(19) United States
(12) Patent Application Publication
(10) Pub. No.: US 2002/0093667 A1
(43) Pub. Date: Jul. 18, 2002

(54) Device for sensing or monitoring moving operations

(76) Inventor: Burghard Hoffmann, Taunusstein (DE)

Correspondence Address: Killworth, Gottman, Hagan & Schaeff, L.L.P., One Dayton Centre, Suite 500, Dayton, OH, 45402-2023, US

(21) Appl. No.: 09/912,255

(22) Filed: Jul. 24, 2001

(30) Foreign Application Priority Data
Jul. 25, 2000 (DE) 100 36 095.5

(51) Int. Cl. G01B 11/14

(52) U.S. Cl. 356/625

(57) ABSTRACT

The present invention is concerned with monitoring moving operations, with an optical sensor (1) and an illuminating means (12). In order to provide a device for sensing or monitoring moving operations, in which an optimum lighting of the sensing area is ensured even when objects of greatly varying sizes are sensed, or respectively when the distance between the camera and the object to be sensed changes significantly from object to object, it is proposed according to the invention that a first deviation mirror (2, 2′) be arranged such that the light leaving the illumination means (12) is reflected.

### BACKGROUND OF THE INVENTION

The present invention relates to a device for sensing or monitoring of moving operations, with an optical sensor and an illuminating means.

In industry, there are numerous processes in which transported goods or substances are transported on conveyor belts. With the aid of the device described in the introduction, for example, the dimensions of the transported goods can be sensed. A further possibility for application is the sensing of optically detectable data affixed to potentially large-area objects. An example of this is, for example, a package distribution system. In a package distribution system, packages of all different sizes are delivered on transporter belts. Affixed to the package is, for example, an address that can be read by the device. Automatic sensing and identification based on the data detected with respect to the transported object is an important prerequisite for automation in package mailing and distribution technology, but also, for example, in storage administration.

Such a device forms the prior art, and is known, for example, from DE 196 39 854. The illuminating and imaging configuration of the known device is shown schematically in FIG. 1. A conveyor belt 4 is shown, on which a package P is transported. Above the conveyor belt 4, a camera 1 and an illuminating means 12 are arranged. The optical axis 10 of the camera 1 and the optical axis 17 of the illuminating means 12 are arranged at an angle to one another so that they intersect approximately at the level of the conveyor belt 4. If the package P now arrives in the illumination plane illuminated by the illuminating means 12, the package surface 9 can be read by the camera 1.

The known devices have the disadvantage, however, that optimally lit sensing of the transported object is possible only in the proximity of the point of intersection of the optical axis of the camera and the optical axis of the illuminating unit. In particular when the transported goods to be sensed vary greatly in size, or the distance between the camera and transported goods can alter, this is disadvantageous. If, for example, in FIG. 1 a significantly larger package were to be sensed, the upper surface 9 of the package would pass through the beam of light 17 of the illuminating means 12 in a plane in which the illuminating cone of the illuminating unit 12 and the optical axis 10 of the camera 1 no longer coincide. The result is insufficient lighting of the upper surface 9 of the package, so the sensing error rate increases.

### BRIEF SUMMARY OF THE INVENTION

The object of the present invention is therefore to provide a device for sensing or monitoring moving operations, in which an optimum lighting of the sensing area is ensured even when objects of greatly varying sizes are sensed, or respectively when the distance between the camera and the object to be sensed changes significantly from object to object.

This object is solved in that a first deviation mirror is arranged such that the light leaving the illuminating means is reflected. In other words, the illuminating means is not orientated directly towards the conveyor belt, or respectively the objects to be sensed, but instead towards a first deviation mirror that in turn reflects the light such that the objects to be illuminated are lit by the reflected light. By means of this mirror it is possible to reduce the angle between the optical axes of the optical sensor and the illuminating unit. Such a reduction is possible only to a very limited extent with the embodiment according to the prior art without the deviation mirror, as because of the geometric expansion of the illuminating unit housing and of the optical sensor, the angle between the optical axes cannot be reduced at will without producing shadows or a partial covering of the visual range of the sensor by the illuminating means.

The optical sensor can, in principle, be any sensor at all. However, in this case the use of a line scanning sensor is particularly preferred, for example, a CCD line scanning camera. With the aid of a line scanning sensor, significantly greater geometric resolutions can be achieved than with conventional surface sensors.

Although with a line scanning camera only one line at a time of a feature can be detected, it is, however, possible to read several consecutive lines, so because of the movement of the feature or respectively the goods transported, two-dimensional sensing of the feature is possible.

Advantageously, the illuminating means is provided with a linear light source, the light of which is focussed with a focussing means. This ensures that the linear sensing surface of the line scanning camera is lit as well as possible.

A particularly preferred embodiment provides that the optical sensor is orientated towards a second deviation mirror, so that the optical axis of the optical sensor is deviated by the mirror. In other words, the optical sensor does not “look” directly at the conveyor belt or respectively the objects to be sensed, but instead at the second deviation mirror that deviates the light reflected from the objects to be sensed to the optical sensor. Using this measure, the angle between the optical axes of the illuminating unit and respectively of the optical sensor can be reduced yet further, as no formation of shadows due to the housing of the illuminating means or of the optical sensor occurs. Moreover, the two deviation mirrors can advantageously be arranged such that the optical axis of the illuminating means and the optical axis of the optical sensor run at least in part parallel to one another.

An embodiment is particularly preferred in which the first deviation mirror lies in a plane that defines two half-spaces, wherein the illuminating means is arranged in one half-space, and the second diverting mirror in the other half-space. In other words, from the point of view of the illuminating means, the second deviation mirror is arranged behind the first deviation mirror the illuminating means. In this way it is ensured that the second deviation mirror cannot cast any shadows, as it is not located within the cone of light emitted by the first deviation mirror.

An embodiment is particularly advantageous in which the first deviation mirror is provided with a preferably slit-shaped interruption, or is composed of at least two adjacently arranged mirrors. Advantageously, the second deviation mirror is arranged such that after being deviated by means of the second deviation mirror, the optical axis of the optical sensor runs through the interruption in the first deviation mirror or between two first deviation mirrors arranged in one plane. By means of this arrangement of the two deviation mirrors, the optical sensor is capable of “seeing” through the interruption in the first deviation mirror. The deviation mirrors are best adjusted so that the beam of light emanating from the illuminating means, and reflected at the first deviation mirror, runs substantially parallel to the reflected light appearing from the objects to be sensed running in the direction of the second deviation mirror.

Advantageously the optical axis of the illuminating optics (the beam of light emanating from the illuminating means) forms an angle α<90° with the plane of the first deviation mirror, and the plane of the second deviation mirror forms an angle γ>45° with the plane of the first deviation mirror.

An arrangement is particularly advantageously in which 100°−α/2>γ>80°−α/2, preferably 95°−α/2>γ>85°−α/2, and particularly preferably γ is approximately 90°−α/2. This arrangement allows particularly compact implementation of the device.

For most instances of application, it can be advantageous when a means for adjusting a and/or a means for adjusting γ is provided. If required, this then allows fine calibration of the optical axes of the sensor and respectively of the illuminating means.

In particular for sensing very large objects being transported, an embodiment is advantageous in which the second deviation mirror is of a length greater than 25 cm, preferably greater than 50 cm, particularly preferably greater than 75 cm. The optical path between the optical sensor and the second deviation mirror is advantageously at least 0.5 m, preferably at least 2 m, particularly preferably 3 m in length. By means of the relatively long optical path, one can obtain spreading, with a small degree of parallax, of the field of view in which the objects being transported are scanned.

A particular embodiment of the present invention provides that the optical path of the optical sensor runs between the optical sensor and the second deviation mirror via at least one, preferably two, convolution mirrors. The convolution mirror or mirrors serve to convolute the optical path between the optical sensor and second deviation mirror, in that after having been deviated by the second deviation mirror, the light reflected from the object to be sensed is reflected by the convoluting mirror or mirrors. The distance between the optical sensor and second deviation mirror can thus be selected to be significantly less than the optical path between the optical sensor and the second deviation mirror.

An embodiment is particularly preferred in which at least to convoluting mirrors are provided, and in which the optical path runs at least twice via the same convoluting mirror. By means of this measure, the distance between the optical sensor and second deviation mirror can be reduced to an even extent, so that compact configuration of the device according to the invention is possible. Clearly, the arrangement of the convoluting mirror is not limited to arrangement between the optical sensor and the second deviation mirror. The convoluting arrangement can advantageously be used in any optical arrangement, in order, for example, to reduce the distance between the optical sensor and the feature to be sensed, without reducing the optical path.

### BRIEF DESCRIPTION OF THE SEVERAL VIEWS OF THE DRAWINGS

Further advantages, features and possibilities for application will be apparent from the following description of a particular embodiment of the invention and the accompanying Figures. There is shown, in:

FIG. 1 is a schematic representation of the illuminating and imaging configuration in the state of the art,

FIG. 2 is a perspective view of a particular embodiment,

FIG. 3 is a schematic view of the convolution arrangement, and

FIG. 4 is a schematic representation of the course of the optical axes of the illuminating means and the optical sensor.

### DETAILED DESCRIPTION

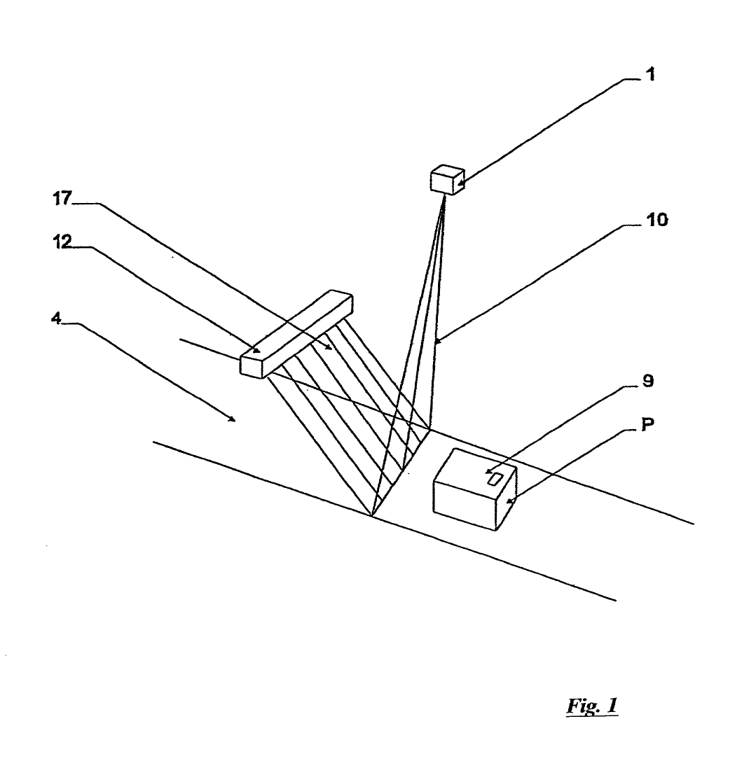

FIG. 1 is a schematic representation of an illuminating and imaging configuration known in the prior art, which was already explained in connection with the discussion of the prior art.

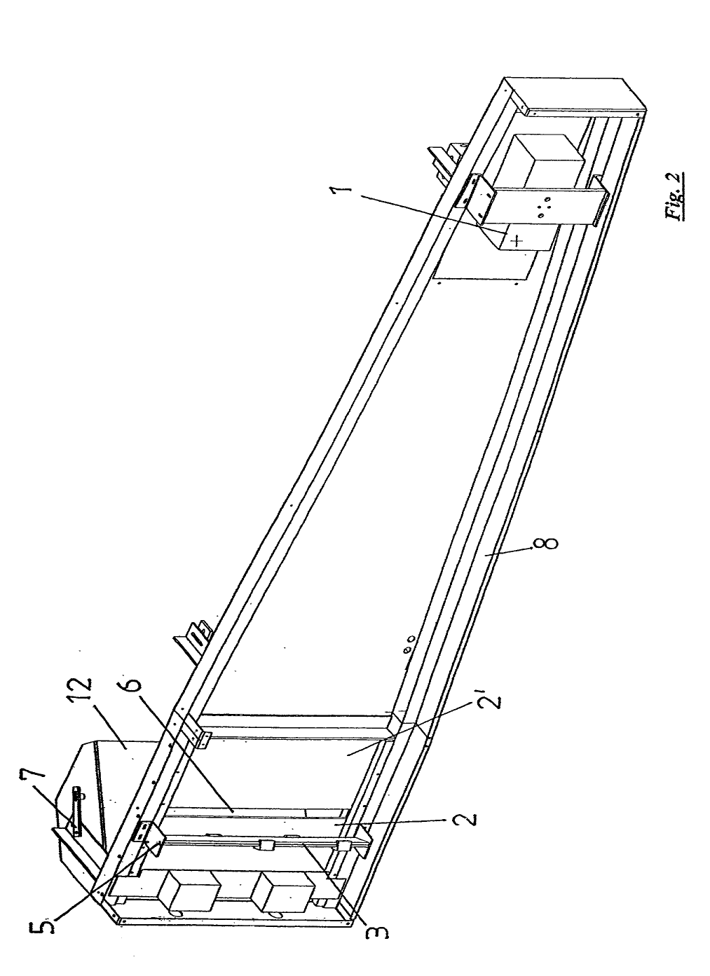

In FIG. 2 an embodiment of the device according to the invention with a line scanning camera 1 and an illuminating means 12 is shown. The device has a frame 8 that is provided to be arranged approximately parallel to the conveyor belt on which the objects to be sensed are moving. The conveyor belt in FIG. 2 runs behind the frame 8. It is clearly apparent that the 5 illuminating means 12 not is directly orientated towards the objects to be sensed, but instead towards a first deviation mirror 2, 2′ that is retained in the frame 8 of the device, and that is seen from the rear in FIG. 2. The beam of light emanating from the illuminating means 12 is thus deviated or respectively reflected on the front side of the first deviation mirror 2, 2′ and then appears on the object to be sensed. The first deviation mirror 2 has, in this case, a viewing slit 6. The viewing slit can either be made in the first deviation mirror 2, 2′, or said mirror can, as is the case with the embodiment shown, be composed of two mirror parts, 2 and 2′ respectively, that lie in one plane and are somewhat apart from one another. In the embodiment shown, the width of the slit is approximately 2 cm. In front of the slit the second deviation mirror 3 is fitted. The line scanning camera 1 this looks onto the second deviation mirror 3 and consequently can thus “look” through the viewing slit 6 onto the transporter band or respectively the objects to be sensed. The angle a at which the beam of light emanating from the illuminating means 12 appears on the first deviation mirror 2, 2′, can be changed or respectively calibrated with the aid of the adjusting device 7.

Furthermore, in the embodiment shown, an adjustment device 5 is shown with which the second deviation mirror 3 can be adjusted such that the angle γ between the plane running through the first deviation mirror and the plane running through the second deviation mirror changes. The device can thus be adjusted such that the optical axis of the beam of light reflected by the illuminating means 12 onto the first deviation mirror 2, 2′ runs parallel to the optical axis of the beam of light deviated on the second deviation mirror 3.

In the embodiment shown, the length of the light slit, and thereby the length of the second deviation mirror 3 is approximately 80 cm. The distance between the second deviation mirror 3 and the line scanning camera 1 is 2 m. In this way a distance between the camera and the feature of approximately 4 m is produced.

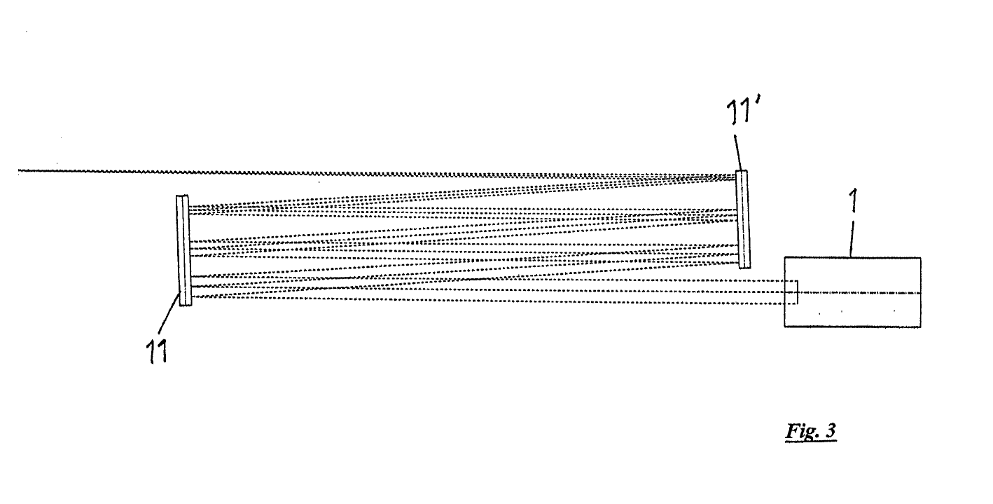

The distance between the second deviation mirror and the line scanning camera can be significantly reduced by means of the use of a convolution arrangement, as is shown in FIG. 3.

Here also, the line scanning camera 1 is shown schematically. Two convoluting mirrors 11, 11′ are arranged such that the optical path going from the line scanning camera 1 to the two convoluting mirrors 11 is deviated several times. The optical path is shown in illustration 3 schematically by broken lines. In the arrangement shown, the optical path is deviated three times by each of the two convoluting mirrors 11, 11′, so the optical path passes along the course of said path between the two convoluting mirrors 11, 11′ six times in all. The course of the optical path that emanates from the line scanning camera 1 is substantially parallel to that emanating from the convoluting arrangement. By means of the convoluting arrangement, it is possible to arrange the line scanning camera 1 very much closer to the second deviation mirror 3, so overall a compact design is possible. Clearly, the second deviation mirror and—if provided—the convoluting mirror have to be of a relatively high optical quality. On the other hand, the first deviation mirror and respectively the first deviation mirrors, can be relatively simple, as long as they just uniformly illuminate the part of a surface to be sensed by the optical sensor.

For clarity, in FIG. 4 a schematic representation of the device according to the invention is shown from above, that is to say looking from above onto the transporter belt 4. The area illuminated by the illuminating means 12 is shown by the broken lines. The optical axis of the optical sensor 1 is shown by a dotted line. In this representation it is clear that after it has “passed through” the second mirror 3, the optical axis of the optical sensor 1 always runs inside the illuminated area. This ensures that the surface to be read on the feature P is optimally illuminated when the distance between the sensor 1 and feature P varies from object to object. This is also indicated by two features P shown in FIG. 4 that are arranged at different distances from the sensing device.

1. A device for monitoring moving operation with a sensor and an illuminating means, wherein a first deviating mirror is arranged such that the light emanating from the illuminating means is reflected.

2. A device according to claim 1, wherein the sensor is a line scanning camera.

3. A device according to claim 1, wherein the illuminating means has an approximately linear light source, the light of which is focussed by a focussing means.

4. A device according to claim 1, wherein the optical sensor is orientated towards a second deviation mirror, so that the optical axis of the optical sensor is deviated by the second deviation mirror.

5. A device according to claim 4, wherein the optical axis of the illuminating means and the optical axis of the optical sensor run in part parallel to one another.

6. A device according to claim 4, wherein the first deviation mirror lies in a plane that defines two half spaces, wherein the illuminating means is arranged in one half space, and the second deviation mirror in the other half space.

7. A device according to claim 1, wherein the first deviation mirror is provided with a preferably slit-shaped interruption or is composed of at least two mirrors arranged in one plane.

8. A device according to claim 7, wherein the second deviation mirror is arranged such that the optical axis of the optical sensor runs through the interruption in the first deviation mirror or between two mirrors arranged in one plane.
